(19) United States
(12) Patent Application Publication
(10) Pub. No.: US 2009/0145928 A1
(43) Pub. Date: Jun. 11, 2009

(54) SAFETY DEVICES FOR CONTAINERS

(76) Inventor: Vincent DE LAFORCADE, Rambouillet (FR)

Correspondence Address: O'BRIEN JONES, PLLC, 8200 Greensboro Drive, Suite 1020A, McLean, VA, 22102, US

(21) Appl. No.: 12/271,831

(22) Filed: Nov. 14, 2008

Related U.S. Application Data
(60) Provisional application No. 61/012,699, filed on Dec. 10, 2007.

(30) Foreign Application Priority Data
Nov. 15, 2007 (FR) 07 59080

(51) Int. Cl. B67D 5/00; B29C 39/00; B65D 83/00

(52) U.S. Cl. 222/153.11; 264/242; 222/402.11; 222/402.13

(57) ABSTRACT

A safety device for a container having a dispenser rod that is controlled by being depressed may comprise a base configured to be secured to the container while the container is in use; and a blocking member pivotally movable relative to the base, and configured to take up an active position in which it opposes depression of the dispenser rod by an endpiece coupled to the dispenser rod, said endpiece being moved by the user in order to cause product to be dispensed, and an inactive position in which it allows the dispenser rod to be depressed, the blocking member being capable of keeping the active or inactive position into which it is placed by the user once the user ceases to act on the blocking member, the blocking member being connected by a hinge to the base.

This application claims the benefits of priority of French Application No. 07 59080 filed on Nov. 15, 2007. This application also claims the benefits of priority of U.S. Provisional Application No. 61/012,699 filed on Dec. 10, 2007, which is incorporated by reference in its entirety herein.

The present teachings relate to containers having a dispenser rod controlled by being depressed, e.g. a valve rod or a pump rod.

### BACKGROUND

Various safety mechanisms have been proposed to prevent accidental operation of the dispenser rod, e.g. while the container is being transported.

Document FR 2 692 559 thus discloses a dispenser head comprising a pushbutton having an endpiece that is coupled with the dispenser rod, the pushbutton being movable relative to a cap that is fastened on the container, which cap has a member for blocking the dispenser rod being hinged thereto to move between an active position that prevents the dispenser rod from being depressed and an inactive position that allows the dispenser rod to be depressed. The dispenser rod is made with a groove, and the blocking member is in the form of a disk that is pierced by an opening in which the dispenser rod is engaged. One end of the opening is sufficiently narrow to enable the disk to engage in the groove and thus prevent the dispenser rod from being depressed. Such a mechanism is relatively complex, requiring a dispenser rod that is provided with a groove and requiring a plurality of separately-fabricated parts to be assembled together.

U.S. Pat. No. 5,282,551 discloses a blocking member that is made integrally with a base that is fastened on the container, the blocking member being connected thereto via bridges of material that are elastically deformable. The blocking member can be moved in translation and needs to be actuated simultaneously with the pushbutton, which is not very convenient for the user.

In U.S. Pat. No. 3,940,023, the safety device automatically returns to a safety configuration in which it opposes depression of the dispenser rod.

Other safety mechanisms are disclosed in FR 2 228 686, FR 2 864 823, U.S. Pat. No. 4,734,349, U.S. Pat. No. 5,131,569, and FR 2 878 511.

### SUMMARY

There exists a need to further improve safety devices, in particular in order to simplify fabrication and reduce the cost thereof, while enabling the product (also referred to as composition) to be dispensed easily.

In one aspect, various exemplary embodiments of the present teachings provide a safety device for a container provided with a dispenser rod that is controlled by being depressed, the dispenser comprising:

a base that is configured to be secured to the container while the container is in use; and

a blocking member that is pivotable relative to the base, being configured to take an active position in which it opposes depression of the dispenser rod by an endpiece coupled to the dispenser rod, the endpiece being moved by the user in order to dispense the product, and an inactive position in which it allows the endpiece to depress the dispenser rod, the blocking member being connected by a hinge to the base and preferably being molded integrally therewith, the blocking member being capable of conserving the active or inactive position into which it is placed by the user once the action of the user on the blocking member ceases.

The dispenser rod controlled by being depressed is moved parallel to its longitudinal axis which may coincide with the longitudinal axis of the container.

Thus, such a device makes it possible to obtain a blocking member suitable for being maintained stably both in its active position and in its inactive position.

By way of example, the blocking member is connected to a radially-inner surface of the base, in particular when the base is annular in shape.

In various exemplary embodiments, the blocking member is configured to snap-fasten on the dispenser rod when the blocking member passes in the inactive position to the active position. Thus, the dispenser rod can co-operate with the blocking member firstly to enable the user to feel passage from the active position to the inactive position, and vice versa, and secondly to keep the blocking member in the configuration in which it has been placed by the user.

The blocking member may include an opening or a notch that is laterally opened for the purpose of passing the dispenser rod of the container.

The above-mentioned notch or opening may have an edge configured to snap-fasten on the dispenser rod during passage of the blocking member from the inactive position to the active position.

The notch or the opening may include first and second edge portions substantially matching the shape of the dispenser rod, these first and second portions being constituted, for example, by circular arcs having the same radius but centers that are offset. These portions may define a ridge where they join that serve for snap-fastening purposes. The opening may have a close outline having for example the general form of the numeral eight. The opening may have two opposed ridges forming the boundary of both circular portions of the eight, the two opposed ridges being overcome via an elastic deformation by the dispenser rod when moving from the active position to the inactive position or vice versa. Each circular portion may have a diameter substantially equal to the diameter of the dispenser rod.

By way of example, the blocking member may present first and second regions that are situated at different heights, e.g. regions of different thicknesses, the second region possibly being thicker than the first, the second region underlying an end edge face of the endpiece when the blocking member is in the blocking position to prevent the endpiece being depressed through a stroke that is sufficient to give rise to dispensing, with only the first region underlying the end edge face of the endpiece when the blocking member is in the inactive position, so that depression of the endpiece is no longer opposed by the second region. Thus, the endpiece can be prevented from being depressed by the blocking member in spite of using a conventional type of dispenser rod that does not include a groove for engaging the blocking member of the kind disclosed in above-mentioned FR 2 692 559.

The blocking member may include two outer uprights defining thrust surfaces against which the user can press to cause it to go from the active position to the inactive position, and vice versa. These uprights may be curved at their bases, e.g. being concave towards each other and towards the dispenser rod; other shapes also are possible.

The blocking member and/or the base may include markings, e.g. “ON” and/or “OFF”, printed and/or molded in relief, or carried by a fitted label, in order to inform the user about the active or inactive nature of the blocking member, depending on its position relative to the base.

The angular stroke of the blocking member may be limited, at least in one direction, by the blocking member coming into abutment against the base.

The angular stroke of the blocking member may be limited, in the opposite direction, by the dispenser rod coming into abutment against the bottom of a notch or an opening in the blocking member.

The base portion may be configured to snap-fasten on the container or to be fastened thereon in some other manner, e.g. by screw-fastening or adhesive. The base may also be integrally molded with at least a portion of the container, where appropriate. The base portion may be annular in shape, as mentioned above.

In an exemplary embodiment of the present teachings, the container is fitted with a dispenser head that includes a lever that defines an actuation surface on which the user can press to cause dispensing to take place; this actuation surface may be situated close to the end of the lever that is opposite to an axis whereby the lever is hinged to the base. Thus, the dispenser head may be actuated in the manner of a “trigger” dispenser head. To start the distribution, the user exerts a force on the lever which tends to pivot the lever, this force having a non-null component oriented perpendicularly to the longitudinal axis of the container. The control surface approaches the axis of the dispenser rod during the movement caused by the user to activate the dispenser rod.

In an exemplary embodiment of the present teachings, the lever has two uprights between which the endpiece extends at least in part, the endpiece possibly being connected to the uprights via flexible bridges of material.

In an exemplary embodiment of the present teachings, the lever has at least a first portion in relief and the base has at least a second portion in relief, with which the first portion in relief can engage by snap-fastening in order to hold the lever in a configuration in which it is folded down onto the base. By way of example the first portion in relief is carried by a duct including the endpiece and serving to convey the product to the ejection orifice(s).

The dispenser head may include a fitted spray nozzle, in particular a nozzle fastened to one end of the above-mentioned duct.

The base, the lever, and the endpiece may be molded as a single piece of thermoplastic material.

The dispenser head may be inscribed within the envelope of the container when the container is observed looking along its axis. This serves to avoid the dispenser head impeding movement of containers along a conveyor of a manufacturing line. For example, the envelope of the container may be cylinder-shaped and the entire dispenser head including the lever and the portion for ejecting the product, may be inscribed within this cylinder when the container is observed along the axis of said cylinder.

The lever may extend at least in part over the uprights of the blocking member.

In another aspect, various exemplary embodiments of the present teachings provide a packaging and dispenser device comprising a container and a safety device as defined above fastened on the container.

By way of example, the container may be an aerosol can.

The container may contain a cosmetic or a product that is not a cosmetic, for example a household cleaner.

Various exemplary embodiments of the present teachings also may provide a method of making a safety device as defined above, the method including the following steps:

molding the base and the blocking member in the active configuration as a single part. This may avoid the dispenser rod being actuated while the safety device is being mounted on the container.

In yet another aspect, various exemplary embodiments of the present teachings provide a safety device for a container having a dispenser rod that is controlled by being depressed, the device comprising:

a base that is configured to be secured to the container during use thereof; and

a blocking member configured to occupy an active position in which it opposes depression of the dispenser rod by an endpiece coupled to the dispenser rod and moved by the user in order to dispense the composition, and an inactive position in which it allows the dispenser rod to be depressed, the blocking member being capable of conserving the active position or the inactive position in which it is placed by the user once the user ceases acting on the blocking member, the blocking member being connected to the base via a hinge, the blocking member being configured to snap-fasten on the dispenser rod when the blocking member passes from the inactive position to the active position. In this aspect of the invention, the blocking member may optionally be made by being molded integrally with the base.

### BRIEF DESCRIPTION OF THE DRAWINGS

The present teachings can be better understood on reading the following detailed description of non-limiting exemplary embodiments thereof, and on examining the accompanying drawings, in which:

FIG. 1 is a diagrammatic perspective view showing an exemplary embodiment of a packaging and dispenser device including a safety device made in accordance with the present teachings;

FIG. 2 shows the dispenser head in isolation of the FIG. 1 device;

FIG. 3 shows the dispenser head in isolation in a molding configuration;

FIG. 4 shows the dispenser head in isolation seen from beneath, the blocking member being in an inactive configuration;

FIG. 5 is an axial half-section of the dispenser head shown in isolation, the blocking member being in an active position;

FIG. 6 is a view analogous to FIG. 5, the blocking member in an active position;

FIG. 7 is an axial half-section in a section plane perpendicular to the plane of FIGS. 5 and 6;

FIG. 8 is a view analogous to FIG. 1 showing a variant exemplary embodiment of a packaging and dispenser device including a safety device in accordance with the present teachings;

FIG. 9 shows the dispenser head in isolation in a molding configuration;

FIGS. 10 and 11 show the dispenser head in isolation in views from beneath, the blocking member being shown respectively in the active configuration and in the inactive configuration;

FIGS. 12 and 13 are fragmentary side views showing the dispenser head respectively while not dispensing and while dispensing;

FIGS. 14 and 15 are diagrammatic and fragmentary perspective views showing another variant exemplary embodiment of the safety device, the blocking member being shown respectively in its active and inactive position;

FIG. 16 is a fragmentary view in elevation showing a variant of the blocking member,

FIG. 17 is a view in elevation of another exemplary embodiment of the dispenser head in a moulding configuration;

FIGS. 18 and 19 are respectively a side view and a front view of the dispenser head of the FIG. 17; and

FIGS. 20 and 21 are sections of the dispenser head of the FIG. 17 according to section lines XVIII and IXX respectively.

### MORE DETAILED DESCRIPTION

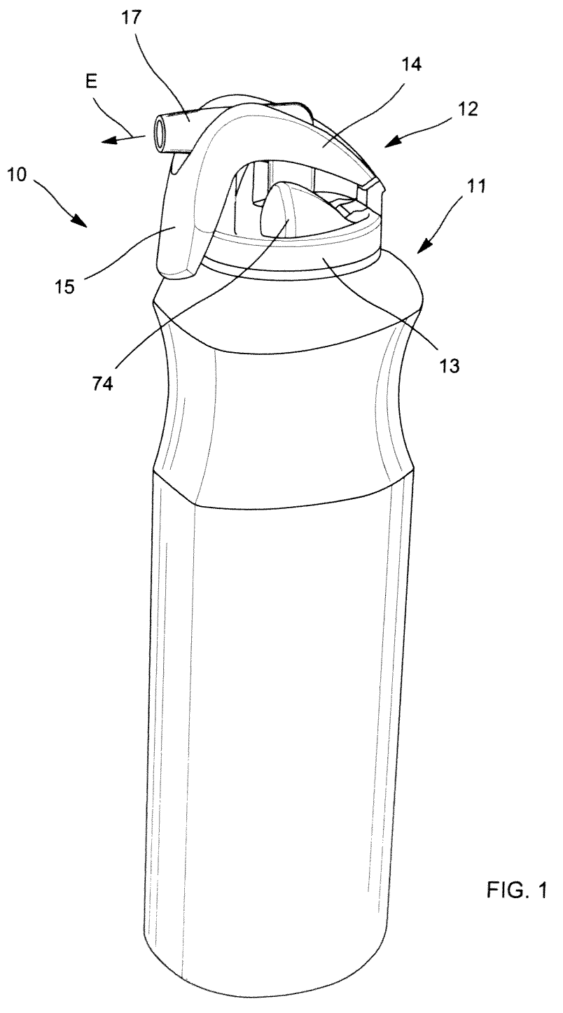

The packaging and dispenser device 10 shown in FIG. 1 comprises a container 11, e.g. an aerosol can, and a dispenser head 12 fastened on the container 11, specifically fitted to the top thereof in the example described.

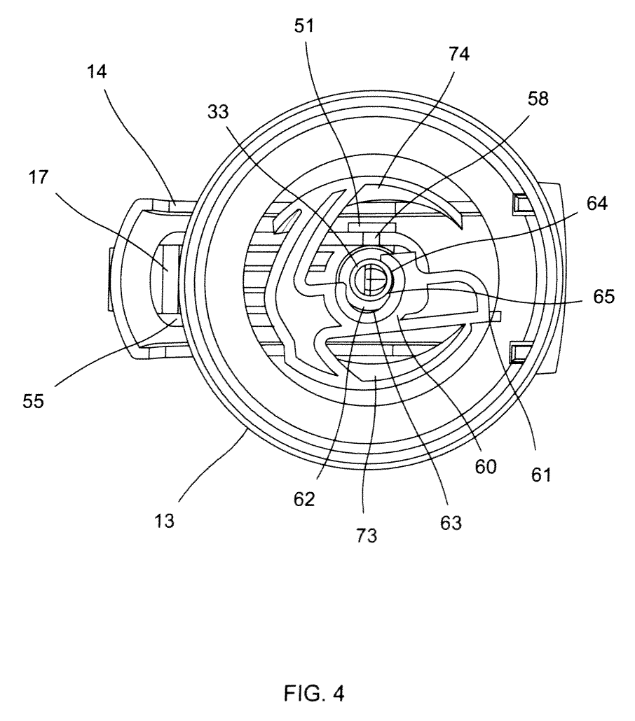

The container 11 includes a valve comprising a hollow dispenser rod 33 that can be seen in FIG. 4, that is operated by being pressed down, and through which the product is dispensed. The valve includes a return member for returning the dispenser rod.

The valve may be of any conventional type for an aerosol can with which those ordinarily skilled in the art are familiar.

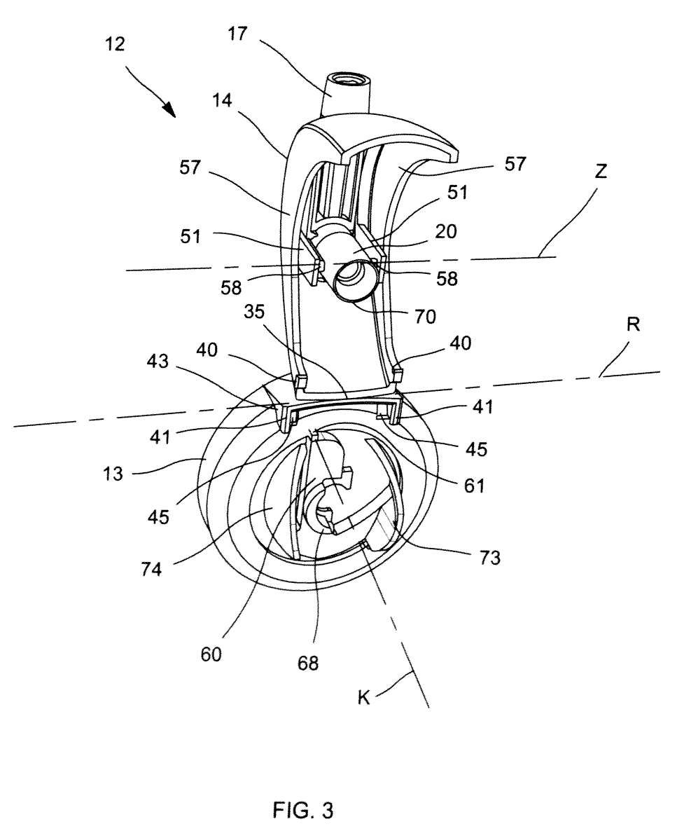

The dispenser head 12 includes a base 13, also referred to as a “band”, that is used for fastening it on the container 11, and a control lever 14 that is hinged to the base 13 to pivot about a pivot axis R (shown in FIG. 3), the lever 14 defining a actuation surface also referred to as control surface 15 on which the user can press to cause the product contained in the container to be dispensed. The control surface 15 is situated at the front of the lever 14, on the side of the dispenser head 12, the head being of the “trigger” type. The control surface 15 is oriented forward.

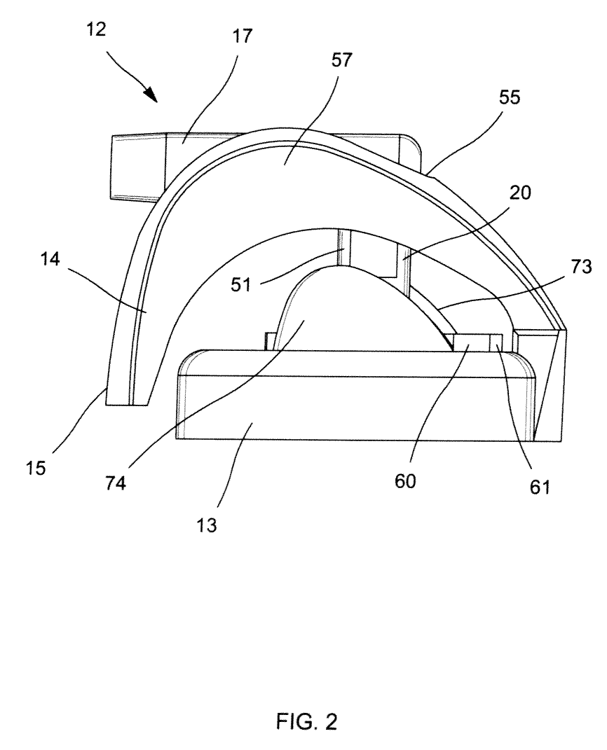

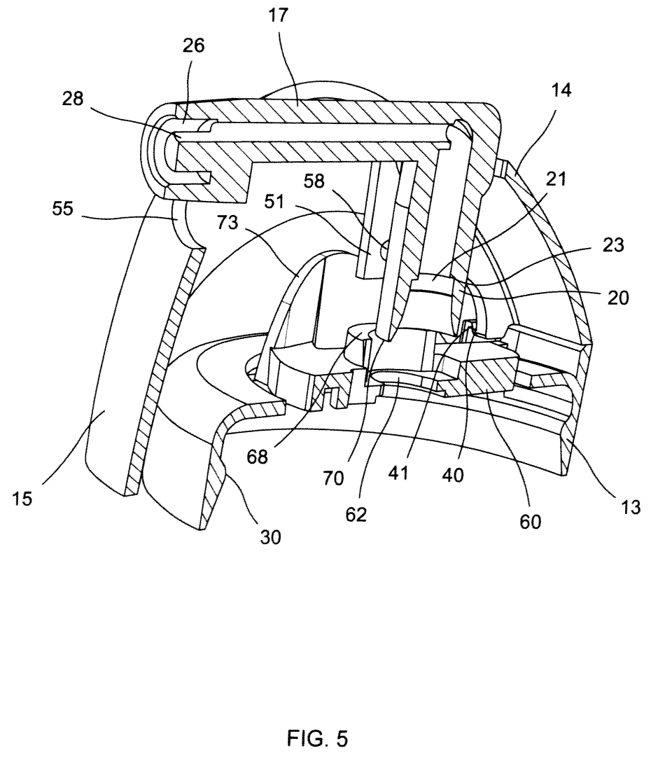

The dispenser head 12 has a duct 17 enabling the product for spraying to be ejected forwardly in a direction E. The direction E is generally perpendicular to the longitudinal axis of the container. In the example shown, the duct 17 includes a portion that forms a connection endpiece 20 that is coupled to the dispenser rod 33, extending substantially parallel thereto, and an ejection portion that extends substantially perpendicularly to the axis of the endpiece 20. The duck 17 may have an ejection portion which extends perpendicularly relative to the endpiece 20, as shown in FIG. 2. The endpiece 20 defines a downwardly-flared housing 21 for receiving the rod 33, this housing 21 being defined at the top by a shoulder 23 against which the rod 33 comes into abutment, as can be seen in FIG. 5.

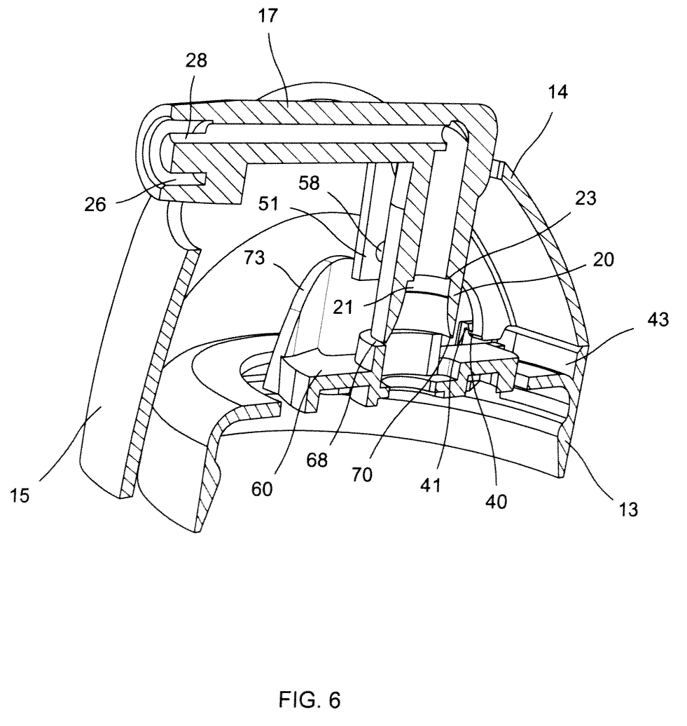

The duct 17 includes an annular housing 26 at its front end, as shown in FIGS. 5 and 6, for receiving a dispenser nozzle (of conventional type and not shown), e.g. a nozzle having swirl channels, or of some other type. In the example shown, the nozzle is fed by a channel 28 in the duct 17.

The base 13 can be fastened on the container 11 in various ways, and in the exemplary embodiment shown the base 13 has an annular bead 30 configured to snap into a corresponding groove (not shown) in the container, e.g. a groove formed by a cup of the container carrying the valve.

With reference to FIG. 3, the lever 14 is hinged to the base 13 about the axis R via a film hinge 35, being integrally molded with the base 13 while in an open configuration, as shown in FIG. 3.

By way of example, the pivot axis R is perpendicular to the longitudinal axis of the container 11.

The lever 14 has first portions in relief 40, such as teeth, that are configured to snap-fasten against second portions in relief 41 formed together with the base 13, so as to act by snap-fastening to retain the lever 14 once it is folded down onto the base 13.

The base has an upright 43 of generally U-shaped cross-section with a web carrying the film hinge 35 and with side flanges having catch rims at their top ends, which rims constitute the second portions in relief 41 and project towards each other. Openings 45 are made in the base 13 to enable these catch rims to be molded.

The endpiece 20 is carried by two uprights 51 that are connected at their top ends to a top wall 52 of the lever 14. The lever also carries two side flanges 57 that extend the top wall 52 downwards. The endpiece 20 and the uprights 51 extend at least in part within the recess formed between the two flanges 57 and the top wall 52.

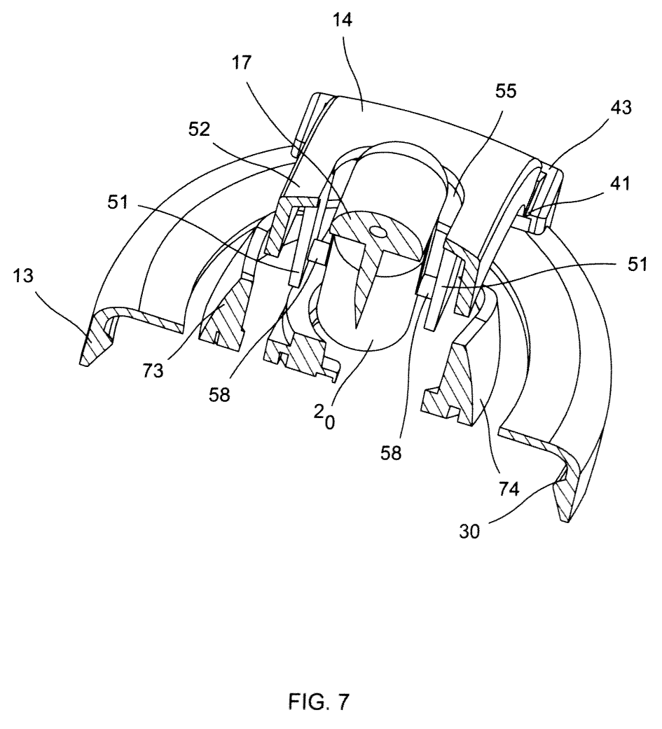

The top wall 52 is pierced by an opening 55 within which the duct 17 extends, as shown best in FIG. 7. The opening 55 also extends towards the front of the lever 14 so as to enable the duct 17 to project forwards relative to the control surface 15, as can be seen in FIG. 2.

The ejection duct 17 and the control surface 15 of the lever 14 may be disposed as shown substantially one above the other and to the side of the base 13. The lower end of the lever may be located as shown above a plane perpendicular to the axis of the dispenser rod and comprising the lower end of the base.

The lever 14 in side view, for example as shown on FIG. 2, may have the form of an arch which goes above the level of the hinge 35 and down under the level of the hinge 35, such that the control surface 15 is at a level under the level of the ejection orifice, in a use position where the container has the dispenser rod oriented vertically and upward. The control surface is for example oriented forward in the use position.

The user holding the container in his hand may activate the trigger by pressing with the forefinger toward the container. The force applied by the user and the ejection direction of the product are for example substantially opposed. The force applied on the control surface has for example a non-null component in a plane perpendicular to the longitudinal axis of the container 11, i.e. a non-null horizontal component when the container is held upright.

The endpiece 20 is connected to the uprights 51 by flexible bridges of material 58, these bridges of material 58 in the example shown being of circular cross-section with an axis Z that is parallel to the pivot axis R.

When the user presses on the control surface 15, the lever 14 can pivot downwards relative to the base 13, thereby likewise tending to entrain the endpiece 20 downwards by means of the uprights 51 and the bridges of material 58. The bridges can deform in twisting about the axis Z so as to enable the endpiece 20 to remain substantially parallel to the axis of the dispenser rod 33 while it is being depressed. The torsion of the bridges enables the endpiece 20 to pivot relative to the lever 14.

When the user releases the lever 14, the return force to which the dispenser rod 33 is subjected returns the endpiece 20 and the lever 14 in an upward direction.

In order to avoid accidental actuation of the dispenser rod 12, it includes a safety device, as described below, serving to selectively block actuation of the dispenser rod 33.

In the embodiment shown in FIGS. 1 to 7, this safety device comprises a blocking member 60 that is connected to the base 13 via a hinge 61 of axis K that is integrally molded with the base 13 and with the blocking member 60. The axis K is parallel to the direction in which the dispenser rod 33 is depressed.

The blocking member 60 can pivot between a first position in which it allows the dispenser rod 33 to be actuated, which position is referred to as its “inactive” (or “unlocked”) position, and a second position in which it blocks such actuation, which position is referred to as its “active” (or “locking”) position.

The blocking member 60 includes a notch 62 that is laterally open, as can be seen in particular in FIG. 4, the notch having an edge that includes a first portion 63 and a second portion 64, both of which are circular and of radius matching the radius of the dispenser rod 33, the centers thereof being offset, these portions 63 and 64 defining a ridge 65 where they join, which ridge is snapped past the control rod 33 when the blocking member 60 goes from the active position to the inactive position, or vice versa.

The blocking member 60 is of varying thickness, having a rib 68 that can bear against the bottom end edge face 70 of the endpiece 20 when the blocking member 60 is in the active position, as shown in FIG. 6, so as to prevent the endpiece 20 moving downwards and actuating the rod 33.

When the blocking member 60 is in the inactive position, the rib 68 is no longer facing the bottom end edge face 70 of the endpiece 20, so the endpiece is free to move downwards along a stroke that is sufficient to actuate the control rod 33 so as to cause product to be dispensed.

The blocking member 60 has two opposite outer uprights 73 and 74 that can be pressed by the user to move the blocking member 60 between its active and inactive positions.

In the example shown, these uprights present a curved shape at their bases, being concave towards each other.

In order to bring the blocking member 60 into the active position, the user presses against the upright 73, thereby forcing the dispenser rod 33 to go past the ridge 65 and be received in the back of the notch 62. In this configuration, the endpiece 20 is prevented from being depressed by the rib 68.

In order to able to dispense the product, the user presses in the opposite direction against the upright 74, thereby bringing the control rod 33 into register with the portion 64 of the edge of the notch 32 and moving the rib 68 away from the bottom end edge face 70 of the endpiece 20, thereby allowing it to be depressed sufficiently to actuate the dispenser rod 33.

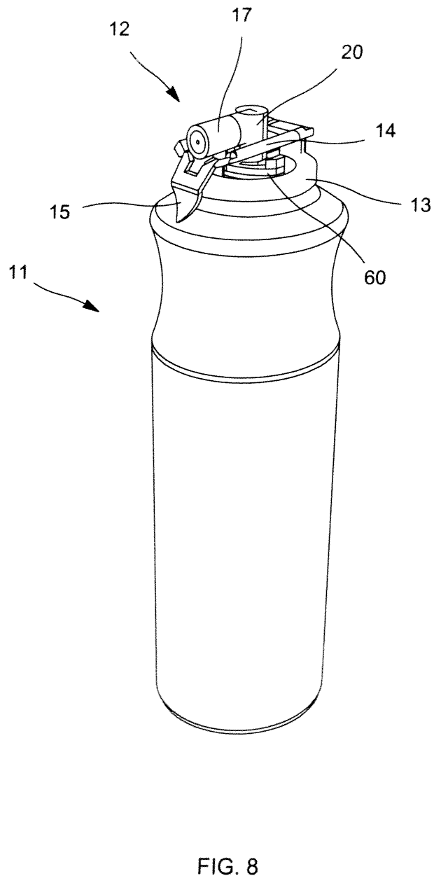

In the exemplary embodiment shown in FIGS. 8 to 13, the dispenser head 12 is made somewhat differently. The same reference symbols are retained to designate elements that are identical or that have the same function as in the above-described embodiment.

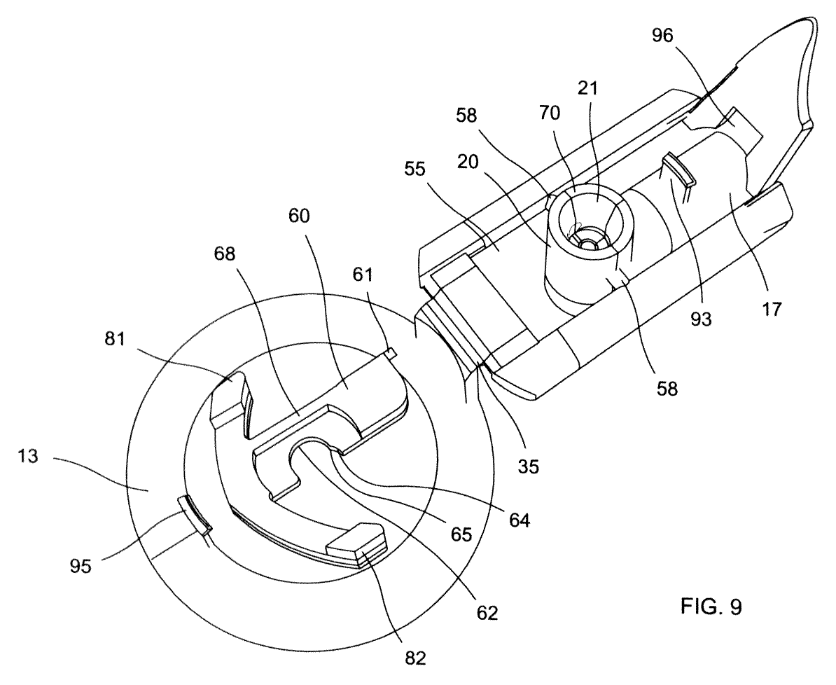

In this embodiment, the blocking member 60, shown best in FIGS. 9-11, is generally anchor-shaped and the user can actuate the ends 81 and 82 thereof so as to move it between its active and inactive positions.

By way of example, in this embodiment the lever 14 is held in the folded-down position by a retaining tab 93 that is carried by the duct 17 and that snap-fastens on a portion in relief 95 of the base, situated remote from the hinge 35. The lever 14 is made with an opening 96 that enables the retaining tab 93 to be molded.

Also in this embodiment, the endpiece 20 is connected directly by means of flexible bridges 58 to the lever 14 between the branches thereof that define the side of the opening 55.

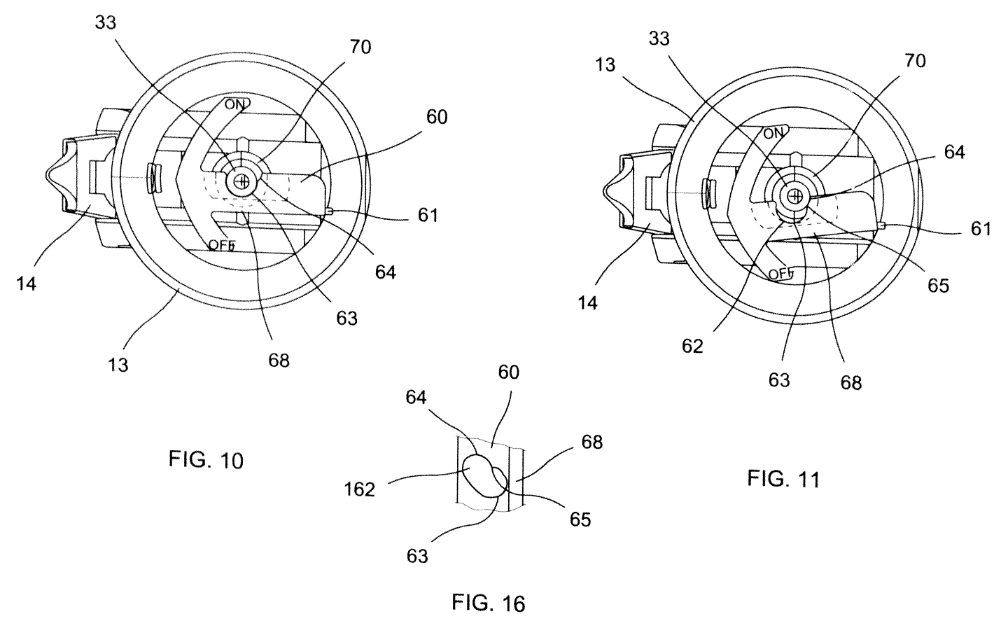

In FIG. 10, it can be seen that the blocking member 60 is in the active position, the bottom edge face 70 of the endpiece 20 partially overlying the rib 68 of the blocking member.

In FIG. 11, it can be seen that the blocking member 60 has moved into the inactive position, the bottom edge face 70 of the endpiece 20 no longer overlying the rib 68 and the endpiece 20 being capable of being depressed further.

In this inactive configuration, the dispenser rod 33 is situated substantially in register with the portion 64 of the edge of the notch 62.

In FIG. 10, the dispenser rod 33 is situated substantially against the portion 63 of the edge of the notch 62.

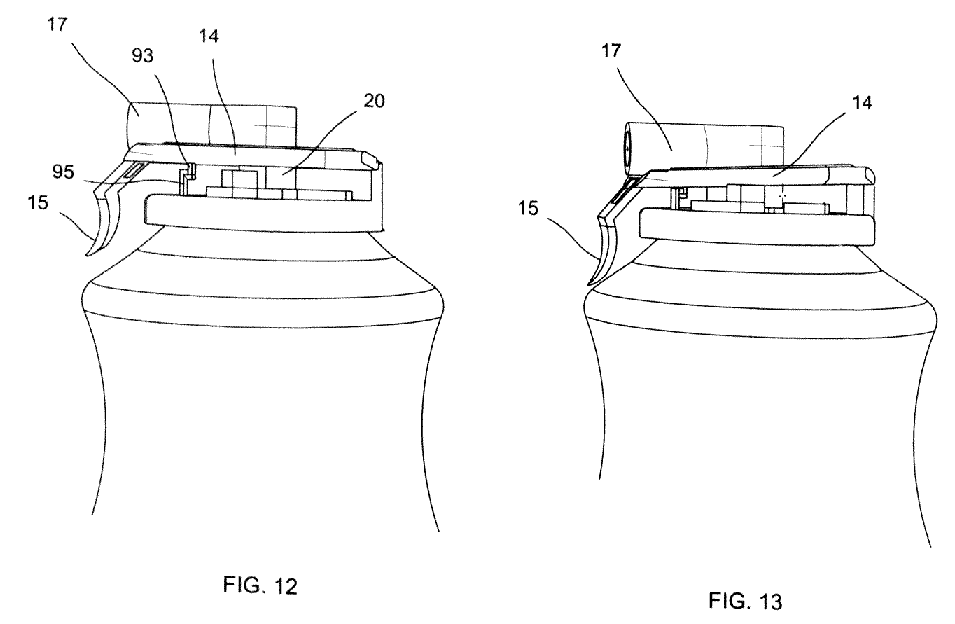

In FIGS. 12 and 13 it can be seen that when the user presses on the control surface 15, the lever 14 can tilt downwards while the bridges of material 58 enable the endpiece 20 to remain substantially on the same axis as the dispenser rod.

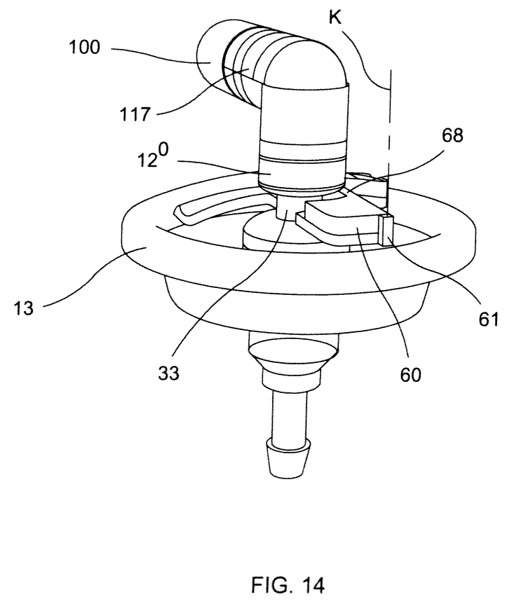

FIGS. 14 and 15 show another exemplary embodiment in which the dispenser head does not include a lever, the user pressing directly on the top of a pushbutton 100 in order to dispense the product. The pushbutton 100 comprises a duct 117 connected to an endpiece 120 that is coupled with the dispenser rod and that is retained thereon, e.g. by friction.

In this exemplary embodiment, the blocking member 60 is generally anchor-shaped, however it could be of some other shape, e.g. it could have the shape described with reference to FIGS. 1 to 7.

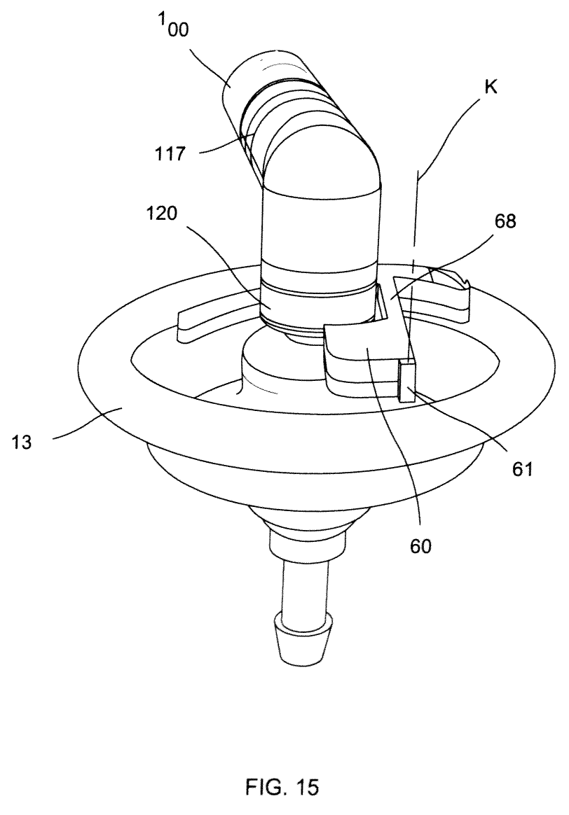

In the exemplary embodiment of FIG. 16, the member 60 includes an opening 162 that replaces the notch 62 and that presents a closed outline.

The dispenser rod 33 is engaged in the opening 162 and can co-operate with the edge portions 63 and 64.

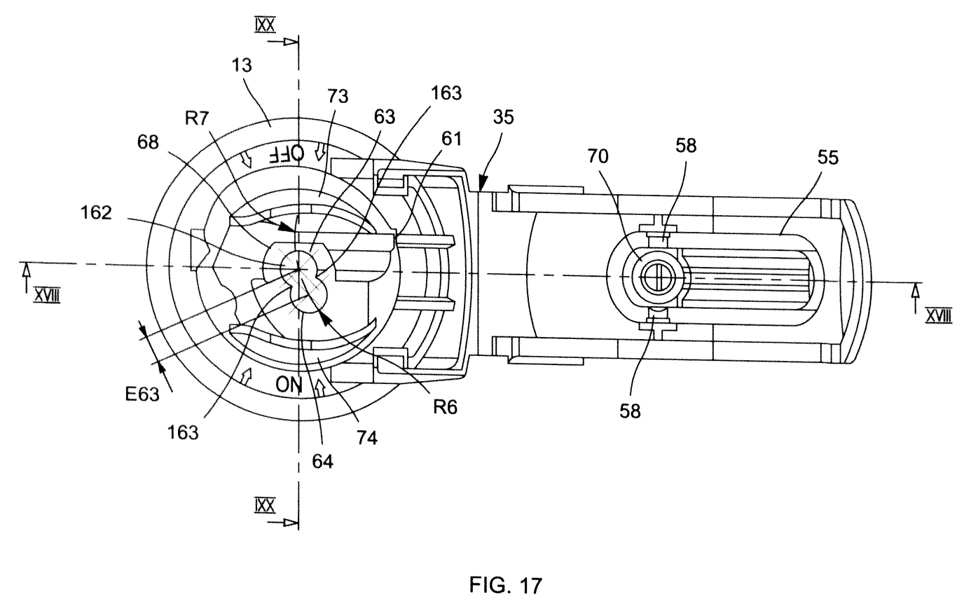

In the exemplary embodiment shown in FIGS. 17-21, the blocking member 60 comprises an opening 162 whose outline is closed and substantially in the form of an eight, in a transverse section taken perpendicularly to the longitudinal axis of the dispenser rod 33. The opening 162 comprises two outline portions that are substantially circular around respective axes spaced from each other by a distance E63 in FIG. 17. The closer the ridges 163 are located at the junction of both circular portions of the outline, the more difficult is the crossing by the dispenser rod of the space formed between these two ridges. The radius R6 of each of the two circular portions of the opening 162 corresponds for example substantially to the outer radius of the dispenser rod 33. The centers of the circular portions are situated on a circular path at the same distance of the axis K of the hinge 61 of the blocking member 60 relative to the base 13.

Visual markings comprising for example the inscriptions “ON” and/or “OFF” and/or arrows may for example be inscribed next to uprights 73 and 74 as illustrated.

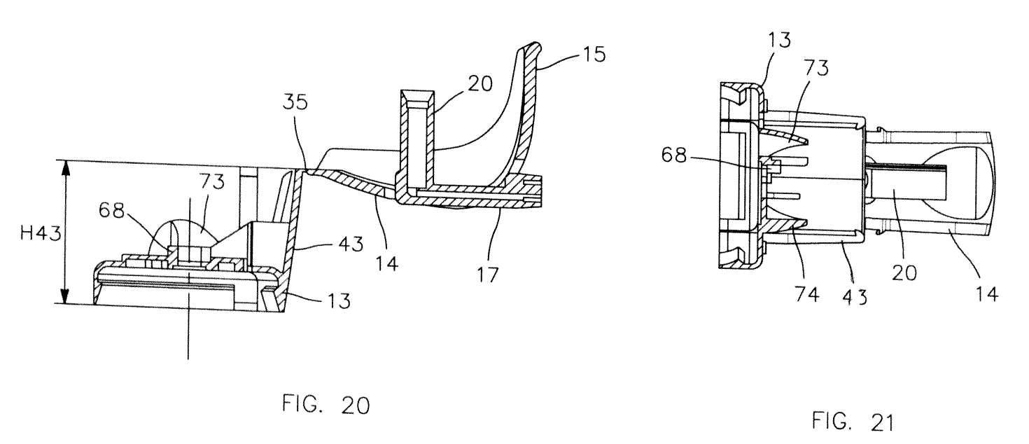

As shown in FIG. 20, the upright 43 of the base 13, on which the hinge is connected, may have a height H43 greater than the height of the corresponding upright of the exemplary embodiment of FIG. 2.

The height H43 is measured between the lower end of the base 13 and the upper end of the upright 43. For example, the hinge 35 may be situated at a height greater than the height of uprights 73 and 74 and greater than the height of the lower end of the endpiece 20 when the lever is at rest and ready to be activated by the user to distribute product. The height H43 is for example greater than or equal to 20 mm, for example ranging from 20 to 30 mm or from 24 to 28 mm or of about 27 mm.

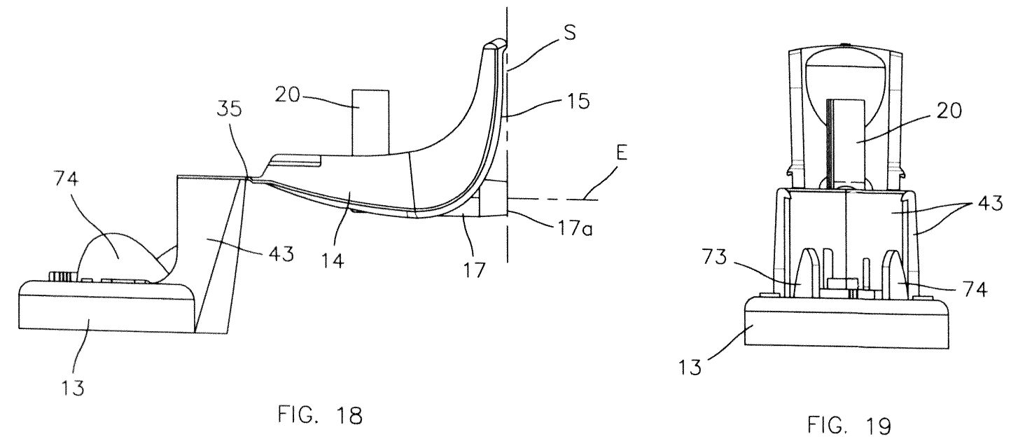

It can be seen in FIG. 18 that the free end 17a of the duct 17 may be situated in a plane S substantially perpendicular to the direction E and forward relative to the control surface 15.

Naturally, the present teachings and claims are not limited to the exemplary embodiments described above.

In particular, the dispenser head can be provided with a resilient return member suitable for returning the lever 14 into its initial position after each actuation, which may be useful when the valve of the container does not present sufficient force.

The dispenser head in may be fitted with a container provided with a pump instead of being fitted to an aerosol can.

The term “comprising a” should be understood as being synonymous with “comprising at least one” unless specified to the contrary.

Although the present teachings reference various exemplary embodiments, it is to be understood that those embodiments are merely illustrative of the principles and applications of the present teachings. It is therefore to be understood that numerous modifications may be made to the illustrative embodiments and that other arrangements may be devised without departing from the spirit and scope of the present teachings and claims.

What is claimed is:

1. A safety device for a container having a dispenser rod that is controlled by being depressed, the safety device comprising:
a base configured to be secured to the container while the container is in use; and
a blocking member pivotally movable relative to the base, and configured to take up an active position in which it opposes depression of the dispenser rod by an endpiece coupled to the dispenser rod, said endpiece being moved by the user in order to cause product to be dispensed, and an inactive position in which it allows the dispenser rod to be depressed, the blocking member being capable of retaining the active or inactive position into which it is placed by the user once the user ceases to act on the blocking member, the blocking member being connected by a hinge to the base.

2. A device according to claim 1, wherein the blocking member is molded as a single piece together with the base.

3. A device according to claim 1, wherein the blocking member defines a laterally-open notch for passing the dispenser rod.

4. A device according to claim 1, wherein the blocking member defines an opening for passing the dispenser rod.

5. A device according to claim 1, wherein the blocking member is configured to snap-fasten on the dispenser rod during placement of the blocking member from the inactive position to the active position.

6. A device according to claim 3, wherein the notch comprises an edge configured to snap-fasten on the dispenser rod during placement of the blocking member from the inactive position to the active position.

7. A device according to claim 6, wherein the notch comprises first and second edge portions substantially matching the shape of the dispenser rod, these edge portions defining an edge suitable for going past the dispenser rod during snap-fastening.

8. A device according to claim 1, wherein the blocking member comprises first and second regions of different heights, the second region underlying an end edge face of the endpiece when the blocking member is in the active position to oppose depression of the endpiece, and only the first region underlying the end edge face of the endpiece when the blocking member is in the inactive position.

9. A device according to claim 1, wherein the blocking member comprises two uprights defining surfaces on which the user can press to cause it to pass from the active position to the inactive position, and vice versa.

10. A device according to claim 9, wherein the uprights are curved at their bases, being concave towards each other and towards the dispenser rod.

11. A device according to claim 1, wherein the blocking member is hinged about a pivot axis substantially parallel to the axis along which the dispenser rod is depressed.

12. A device according to claim 1, wherein the base is configured to snap-fasten on the container.

13. A device according to claim 1, wherein the angular stroke of the blocking member is limited at least in one direction by the blocking member coming into abutment against the base.

14. A device according to claim 13, wherein the angular stroke of the blocking member is limited in a direction opposite the at least one direction by the dispenser rod coming into abutment against the bottom of a notch or an opening in the blocking member.

15. A device according to claim 4, wherein the opening comprises an edge configured to snap-fasten on the dispenser rod during placement of the blocking member from the inactive position to the active position.

16. A device according to claim 15, wherein the opening comprises first and second edge portions substantially matching the shape of the dispenser rod, these edge portions defining an edge suitable for going past the dispenser rod during snap-fastening.

17. A packaging and dispenser device comprising a container and a safety device fastened on the container having a dispenser rod that is controlled by being depressed, the safety device comprising:
a base secured to the container while the container is in use; and
a blocking member pivotally movable relative to the base, and configured to take up an active position in which it opposes depression of the dispenser rod by an endpiece coupled to the dispenser rod, said endpiece being moved by the user in order to cause product to be dispensed, and an inactive position in which it allows the dispenser rod to be depressed, the blocking member being capable of retaining the active or inactive position into which it is placed by the user once the user ceases to act on the blocking member, the blocking member being connected by a hinge to the base.

18. A device according to claim 17, wherein the container is an aerosol can.

19. A device according to claim 17, wherein the container contains a cosmetic.

20. A device according to claim 17, wherein the container contains a household cleaner.

21. A method of making a safety device for a container having a dispenser rod that is controlled by being depressed, the method comprising:
molding as a single piece a base and a blocking member in an active position to form a safety device comprising:
the base, wherein the base is configured to be secured to the container while the container is in use; and
the blocking member, wherein the blocking member is pivotally movable relative to the base, and configured to take up an active position in which it opposes depression of the dispenser rod by an endpiece coupled to the dispenser rod, said endpiece being moved by the user in order to cause product to be dispensed, and an inactive position in which it allows the dispenser rod to be depressed, the blocking member being capable of retaining the active or inactive position into which it is placed by the user once the user ceases to act on the blocking member, the blocking member being connected by a hinge to the base.
